(19) United States
(12) Patent Application Publication
(10) Pub. No.: US 2013/0016517 A1
(43) Pub. Date: Jan. 17, 2013

(54) Aircraft Washlight System

(71) Applicants: David P. Eckel, Fort Salonga, NY (US); Gannon T. Gambeski, Saint James, NY (US); William H. Valentine, JR., Edmonds, WA (US)

(72) Inventors: David P. Eckel, Fort Salonga, NY (US); Gannon T. Gambeski, Saint James, NY (US); William H. Valentine, JR., Edmonds, WA (US)

(73) Assignee: B/E AEROSPACE, INC., Wellington, FL (US)

(21) Appl. No.: 13/546,475

(22) Filed: Jul. 11, 2012

Related U.S. Application Data
(63) Continuation-in-part of application No. 12/566,146, filed on Sep. 24, 2009.
Application No. 12/566,146 is a continuation-in-part of application No. 13/034,983, filed on Feb. 25, 2011.
(60) Provisional application No. 61/099,713, filed on Sep. 24, 2008.
(60) Provisional application No. 61/105,506, filed on Oct. 15, 2008.
(60) Provisional application No. 61/308,171, filed on Feb. 25, 2010.
(60) Provisional application No. 61/320,545, filed on Apr. 2, 2010.
(60) Provisional application No. 61/345,378, filed on May 17, 2010.

(51) Int. Cl. B60Q 3/02; B64D 47/02

(52) U.S. Cl. 362/471; 362/520

(57) ABSTRACT

Aircraft washlight systems having an asymmetric lens are disclosed. An example vehicle cabin illumination system includes a light source located one side of a surface of a vehicle cabin, and an asymmetric lens through which the light passes to illuminate the surface with a substantially uniform light distribution.

### CROSS REFERENCE TO RELATED APPLICATIONS

The present application is a continuation-in-part of U.S. patent application Ser. No. 12/566,146, filed on Sep. 24, 2009, which claims the priority benefit of U.S. Provisional Application No. 61/099,713, filed Sep. 24, 2008, entitled, “An Aircraft LED Washlight System and Method for Controlling Same” and U.S. Provisional Application No. 61/105,506, filed Oct. 15, 2008, entitled, “An Aircraft LED Washlight System and Method for Controlling Same.”

The present application is also a continuation-in-part of U.S. patent application Ser. No. 13/034,983, filed Feb. 25, 2011, which claims the priority benefit of U.S. Provisional Application No. 61/308,171, filed Feb. 25, 2010, entitled “Lighting System for Vehicle Cabin,” U.S. Provisional Application No. 61/320,545, filed Apr. 2, 2010, entitled “Lighting System for Vehicle Cabin,” and U.S. Provisional Application No. 61/345,378, filed May 17, 2010, entitled “Lighting System for Vehicle Cabin.” All of the above-referenced applications are herein incorporated by reference in their entirety.

### FIELD OF THE DISCLOSURE

This disclosure relates generally to an aircraft washlight system and, more particularly, to an aircraft washlight system having an asymmetric lens.

### BACKGROUND

Washlights are used to provide lighting accents generally via indirect lighting. That is, an area is illuminated with a smooth and even wash of light by light sources that are substantially hidden from direct line of sight by passengers and generally reflected off of another surface. For vehicles in general, and more specifically aircraft, washlights can be used to create various moods and scenes, particularly when colored lighting is used. The use of an aircraft should be considered exemplary herein for a type of vehicle and as an embodiment of the invention. However, nothing limits the invention to an aircraft.

### DESCRIPTION OF THE DRAWINGS

The invention is described below with reference to the drawings that illustrate various embodiments of the invention.

FIGS. 1 and 2 illustrate an exemplary cabin model including a ceiling washlight unit having an asymmetric lens;

FIG. 3 is a graph showing an illumination pattern of the ceiling washlight unit without the asymmetric lens;

FIG. 4 is a graph showing an illumination pattern of the ceiling washlight unit with the asymmetric lens, according to an embodiment of the invention;

FIG. 5 is a side view showing measurements of an exemplary asymmetrical lens; and

FIG. 6 is a perspective view of a ceiling washlight unit having the asymmetrical lens of FIG. 5.

### DETAILED DESCRIPTION OF THE PREFERRED EMBODIMENTS

Traditionally, light sources are provided on as many edges of edge-lit panels as possible to maximize the uniformity of illumination. However, even with light sources fully surrounding edge-lit panels, the center of such panels are less well illuminated than the edges because of the center's greater distance from the light sources. The present disclosure incorporates asymmetrical lenses that direct more energy to those areas of the panel that are farthest from the light source or sources (and conversely, less energy toward those areas closest to light source), thus, providing a substantially more even distribution of illumination, and the ability to reduce the number of light sources while providing substantially more uniform illumination. This opportunity to reduce the number of light sources reduces the weight, cost and complexity of the installation.

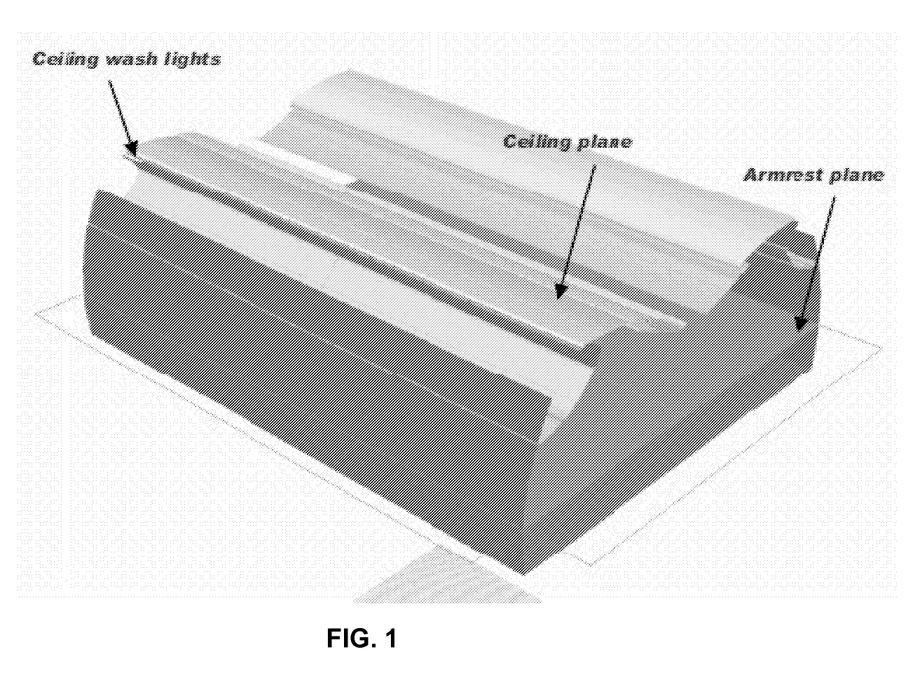

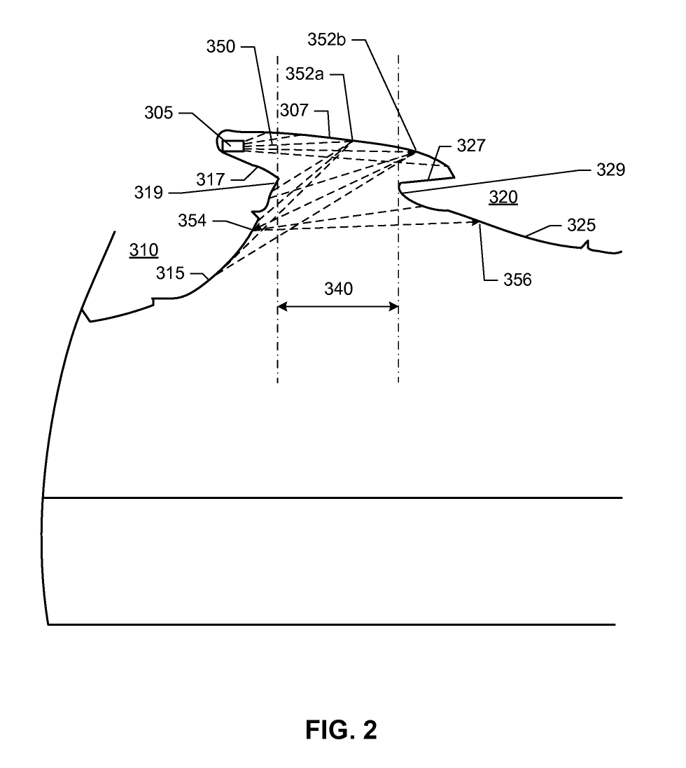

Traditionally, lighting units are placed on both sides of an aisle to provide uniform illumination. It is herein recognized, as shown in FIGS. 1 and 2, that in order to reduce cost, complexity and weight, one may employ a light source on only one side of an aisle directed at a surface, typically a stowage bin face, which is oriented to reflect light back toward the bins under the light source. This design further reveals that, when the light source is located on inboard bins in a two-aisle aircraft, the illumination of the center bins by reflected light will be complemented by light from the sidewall wash lighting and, under many circumstances, passenger windows. In some examples, surfaces may be coated and/or painted (e.g., white or black) to enhance uniformity of illumination.

A lighting system is provided employing one or more asymmetrical lenses to illuminate an adjacent surface. The lighting system comprises a light source located on only one edge of an illuminated surface. This lighting system may be utilized for a ceiling of an airplane employing one or more asymmetrical lenses to illuminate an adjacent surface.

In this design, a light source may be focused onto a first surface with a lens, the first surface being oriented to reflect light onto a second surface. The light source and lens may be located over a bin, valence, or similar structure on one side of an aisle, the first surface being located on the opposite side of the aisle from the light source and lens, and the second surface being located on the same side of the aisle as the light source and lens.

In a two-aisle airplane in which, with respect to one or both longitudinal halves of the airplane, the second surface may be located on the opposite side of each the aisle from the windows. Advantageously, by providing only one set of lights instead of two sets, a reduced number of lights is required to achieve equivalent lighting performance.

In a preferred embodiment light-emitting diode (LED) light sources are used due to their low power and weight. Since the LEDs are available in light primary colors, they can be combined to produce essentially any desired lighting color and level. The present system permits coordinating various lighting systems to provide an overall cohesive illumination effect for a vehicle cabin.

Various embodiments shown in the drawings focus on ceiling washlights. By placing these lights at particular positions, and providing them with various orientations/rotations, desirable effects can be achieved.

FIGS. 1 and 2 illustrate a cabin model used to demonstrate the substantially more uniform illumination created using asymmetric lenses. As shown in FIG. 2, a lighting unit 305 including a light source and an asymmetric lens are located above a first storage bin 310 to illuminate a ceiling surface 307 of an aircraft. The surface 307 defined herein is one having a generally flat or simple curve shape to it (i.e., no inflection points), although it need not be a contiguous surface with possible small gaps. Light rays 350 emanating from the lighting unit 305 illuminate the ceiling surface across its width, including at ray point one 352a and ray point two 352b that are arbitrary points used for illustration purposes herein. It should be clear, however, that ray point one 352a and ray point two 352b are just two arbitrary ray points from an infinite number extending from the lighting unit 305 to the ceiling surface 307.

Since the ceiling surface 307 diffuses the light, each of the illuminated ceiling points, including ray point one 352a and ray point two 352b, have light rays that illuminate a surface 315 of the first storage bin, with each of ray point one 352a and ray point two 352b making a contribution. In this way, even though a protrusion 319 of the first storage bin prevents light rays 350 from the light source from illuminating the first storage bin surface 315, the first storage bin surface 315 is illuminated by light diffused from the ceiling surface 307.

In a similar manner, a light ray point 354 from the first storage bin surface 315 (and all other light ray points) originates light rays that shine onto the second storage bin surface 325, e.g., at light ray point 356 (and others). In this way, illumination from the first storage bin surface 315 can illuminate the second storage bin surface 325 even though a protrusion 329 of the second storage bin may preclude direct illumination from the lighting unit 305 and possibly also the ceiling surface 307. Thus, three surfaces of the ceiling 307, the first storage bin 315, and the second storage bin 325 can be illuminated from a single light source, despite the fact that only one of them receives direct rays 350 from the illumination source 305. Any of the surfaces 307, 315, 325 may be substantially flat or have a significant curvature to them.

First and second valence surfaces 317 and 327 of the first storage bin 310 and a second storage bin 320 may be coated and/or painted to enhance the uniformity of reflected light—the painting or coating can be patterned to create the uniform affect that takes into account both the curvature of the ceiling surface 307 and of the valence surfaces 317, 327 themselves. In the example of FIGS. 1 and 2, the second storage bin 320 is an inboard storage bin but may, alternatively, be a second outboard storage bin substantially similar to the first storage bin 310. That is, the lighting unit 305 may be used to provide substantially uniform ceiling washlight in single or dual-aisle aircraft.

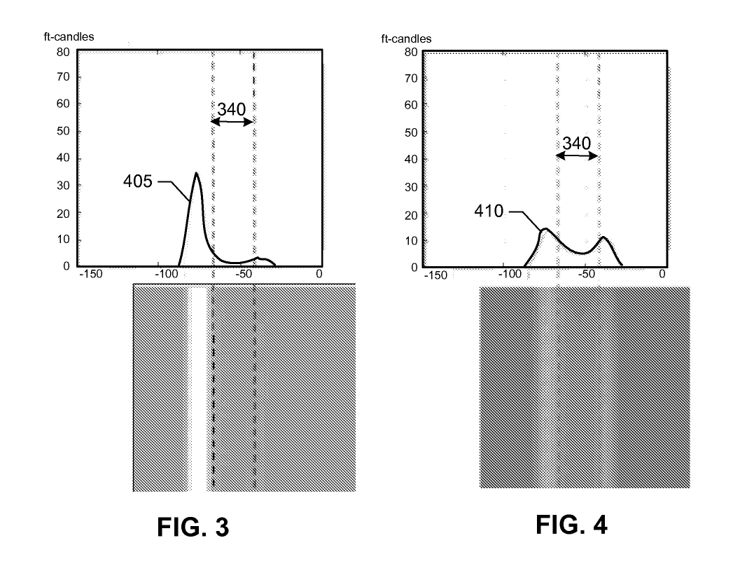

FIG. 3 is a graph illustrating an illumination pattern 405 created by the example model of FIGS. 1 and 2 when the lighting unit 305 does not include an asymmetric lens. As shown in FIG. 3, the illumination pattern provides strong illumination near to the lighting unit 305 that drops off quickly in the space 340 between the storage bins 310 and 320. For modeling purposes, white Nichia LEDs having a clear window were used, although clearly other LEDs could be used. The Nichia LED output was based on specification sheets that indicated white LED output 14 lumens [Rank P6] at 60 milli-Amps (mA). Assuming a 25% duty cycle at 120 mA for maximum current and 88% for thermal derating, the Nichia LED output was modeled to be 14 lumens×(120 mA×0.25/60 mA)×0.88=6.2 lumens. A linear array of LEDs located along the length of the storage bin 310 was modeled.

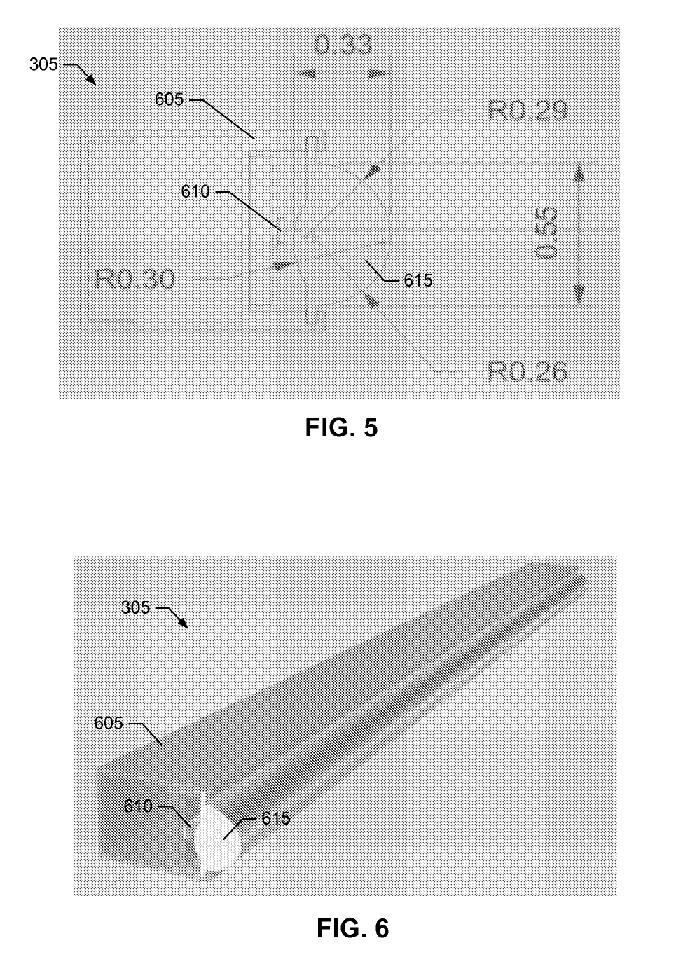

In an advantageous embodiment, the clear window is replaced with an asymmetric lens that shifts some of the light towards the center of the ceiling surface 307. FIG. 5 a graph illustrating an illumination pattern 410 created by the example model of FIGS. 2 and 3 when the lighting unit 305 includes the asymmetric lens. Compared to the illumination pattern 405, the illumination pattern 410 is substantially more uniform across the ceiling surface 307.

FIGS. 5 and 6 illustrate an example lighting unit 305 having a body 605, a linear array of LEDs 610 and an elongated asymmetric lens 615. As shown in FIG. 6, the lighting unit 305 has an elongated shape corresponding to longitudinal axis of an aircraft cabin. Exemplary asymmetric lens dimensions and position are shown in FIG. 5. As shown in FIG. 5, the lens 610 is displaced with respect to the LED array 605 and, thus, light emitted by the LED array 605 is shifted toward the center of the ceiling surface 307.

For the purposes of promoting an understanding of the principles of the invention, reference has been made to the preferred embodiments illustrated in the drawings, and specific language has been used to describe these embodiments. However, no limitation of the scope of this disclosure is intended by this specific language, and this disclosure should be construed to encompass all embodiments that would normally occur to one of ordinary skill in the art in view of this disclosure.

The particular implementations shown and described herein are illustrative examples of the invention and are not intended to otherwise limit the scope of this disclosure in any way. For the sake of brevity, conventional electronics, control systems, software development and other functional aspects of the systems (and components of the individual operating components of the systems) may not be described in detail. It should be noted that many alternative or additional functional relationships or physical connections may be present in a practical device. Moreover, no item or component is essential to the practice of the invention unless the element is specifically described as “essential” or “critical”.

The use of the terms “a” and “an” and “the” and similar referents in the context of describing the embodiments (especially in the context of the following claims) are to be construed to cover both the singular and the plural. The use of any and all examples, or exemplary language (e.g., “such as”) provided herein, is intended merely to better illuminate the invention and does not pose a limitation on the scope of this disclosure unless otherwise claimed.

The words “mechanism” and “element” are intended to be used generally and are not limited solely to mechanical embodiments. Numerous modifications and adaptations will be readily apparent to those skilled in this art without departing from the spirit and scope of this disclosure.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

### TABLE OF REFERENCE CHARACTERS

305 lighting unit
307 ceiling surface
310 first storage bin
315 first storage bin surface
317 first storage bin valence surface
319 first storage bin protrusion
320 second storage bin
325 second storage bin surface
327 second storage bin valence surface
329 second storage bin protrusion
340 space between the first and second storage bins
350 light rays
352a light ray point one on ceiling surface
352b light ray point two on ceiling surface
354 light ray point on first storage bin surface
356 light ray point on second storage bin surface

What is claimed is:

1. A vehicle cabin illumination system comprising:
a light source located only on one side of a surface having a generally flat or simple curve shape of a vehicle cabin; and
an asymmetric lens through which the light passes to illuminate the surface with a substantially uniform light distribution using only the light source.

2. The vehicle cabin illumination system of claim 1, wherein the vehicle cabin comprises an aircraft cabin, and the surface comprises a ceiling surface of the aircraft cabin.

3. The vehicle cabin illumination system of claim 1, wherein the light source comprises a linear array of light emitting diodes.

4. The vehicle cabin illumination system of claim 3, wherein the asymmetric lens has an elongated shape.

5. The vehicle cabin illumination system of claim 4, wherein in a longitudinal center line of the asymmetric lens is offset with respect to the light source.

6. The vehicle cabin illumination system of claim 1, wherein in a center line of the asymmetric lens is offset with respect to the light source.

7. The vehicle cabin illumination system of claim 1, wherein the light source and the asymmetric lens are located at least partially below the surface

8. The vehicle cabin illumination system of claim 1, wherein the light source and the asymmetric lens are located above a storage bin along an edge of the surface.

9. The vehicle cabin illumination system of claim 1, wherein the asymmetric lens is configured and positioned to shift light toward a center of the surface.

10. The vehicle cabin illumination system of claim 1, wherein:
the surface is a ceiling surface;
the light source is located above a surface of a first storage bin but does not directly illuminate the first storage bin surface; and
the first storage bin surface is illuminated primarily from light diffusing from the ceiling surface.

11. The vehicle cabin illumination system of claim 10, wherein a protrusion of the first storage bin blocks light from the light source from directly reaching the surface of the first storage bin.

12. The vehicle cabin illumination system of claim 10, wherein:
the light source is located above a surface of a second storage bin separated by a horizontal space from the first storage bin, but the light source does not directly illuminate the second storage bin surface; and
the second storage bin surface is illuminated primarily from light diffusing from the first storage bin surface.

13. The vehicle cabin illumination system of claim 12, wherein at least one of the first storage bin surface and the second storage bin surface are substantially curved surfaces.
